(19) United States
(12) Patent Application Publication
(10) Pub. No.: US 2021/0003676 A1
(43) Pub. Date: Jan. 7, 2021

(54) SYSTEM AND METHOD

(71) Applicant: KABUSHIKI KAISHA TOSHIBA, Minato-ku (JP)

(72) Inventors: Kentaro YOSHIOKA, Kawasaki (JP); Hidenori OKUNI, Yokohama (JP); Tuan Thanh TA, Kawasaki (JP); Akihide SAI, Yokohama (JP)

(73) Assignee: KABUSHIKI KAISHA TOSHIBA, Minato-ku (JP)

(21) Appl. No.: 16/818,427

(22) Filed: Mar. 13, 2020

(30) Foreign Application Priority Data
Jul. 3, 2019 (JP) 2019-124775

(51) Int. Cl. G01S 7/4861; G01S 7/48; G01S 17/10

(52) U.S. Cl. CPC G01S 7/4861; G01S 17/10; G01S 7/4808

(57) ABSTRACT

A system has detection circuitry configured to detect position information on a first point and a second point of a reflective member based on a first primary reflected electromagnetic wave generated by a reflection of a first emitted pulse on the first point and a second primary reflected electromagnetic wave generated by a reflection of a second emitted pulse on the second point, and processing circuitry configured to estimate an angle of inclination of the reflective member relative to a reference surface of the detection circuitry based on the position information on the first point and the second point.

### CROSS REFERENCE TO RELATED APPLICATIONS

This application is based upon and claims the benefit of priority from the prior Japanese Patent Application No. 2019-124775, filed on Jul. 3, 2019, the entire contents of which are incorporated herein by reference.

### FIELD

Embodiments described herein relate generally to a system and a method.

### BACKGROUND

A technique to generate a distance image in which objects are colored depending on distances has been proposed. In order to generate a distance image, a function is needed to measure a distance by emitting a laser light from a vehicle with the emission direction changed, receiving a reflected light of the laser light, and measuring a distance based on a period of time from the emission timing to the reception timing.

Laser light has a characteristic to be reflected on a reflective member such as a mirror. It is therefore possible that when a laser light for measuring a distance is emitted to a mirror, the laser light is reflected on the mirror and moves toward an object, reflected on the object, and reflected again on the mirror before being received at the original location. If a distance image is generated based on the received laser light, the obtained distance image includes a virtual image that looks like being present in the back side of the mirror. However, the actual object is located prior to the mirror. Since the distance measurement using laser light measures a distance based on the length of light path of the laser light, whether the laser light reflected on the object or reflected on the mirror cannot be known.

The virtual image that can be viewed in the mirror in the distance image may be converted to a real image by means of a numerical simulation if the angle of inclination of the mirror is known. A technique is therefore needed to accurately calculate the angle of inclination of the mirror.

### BRIEF DESCRIPTION OF THE DRAWINGS

FIG. 1 is a block diagram illustrating a schematic configuration of a system according to a first embodiment.

FIG. 2 is a plan view of a plane reflective member viewed from above.

FIG. 3 is a flowchart of an operation of the system according to the first embodiment.

FIG. 4 is a block diagram illustrating a schematic configuration of a system according to a second embodiment.

FIG. 5A is a schematic diagram of a waveform of a laser light received by a light receiver.

FIG. 5B is a diagram illustrating a secondary reflected laser light reflected on an object.

FIG. 6 is a flowchart of an operation of the system according to the second embodiment.

FIG. 7 is a block diagram illustrating a schematic configuration of a system according to a third embodiment.

FIG. 8 is a flowchart of an operation of the system according to the third embodiment.

FIG. 9A is a diagram of a first example of a reflective member capable of increasing the ratio of diffused reflection.

FIG. 9B is a diagram of a second example of the reflective member capable of increasing the ratio of diffused reflection.

FIG. 9C is a diagram of an example of a reflective member capable of increasing the recognition rate of a recognition unit.

FIG. 10 is a block diagram illustrating a schematic configuration of a system including any of the systems according to first to fourth embodiments.

FIG. 11 is a diagram for explaining an operation of a real image converter.

### DETAILED DESCRIPTION

A system according to one embodiment has detection circuitry configured to detect position information on a first point and a second point of a reflective member based on a first primary reflected electromagnetic wave generated by a reflection of a first emitted pulse on the first point and a second primary reflected electromagnetic wave generated by a reflection of a second emitted pulse on the second point, and processing circuitry configured to estimate an angle of inclination of the reflective member relative to a reference surface of the detection circuitry based on the position information on the first point and the second point.

Embodiments of a system and a method will now be described with reference to the accompanying drawings. Although most of the following descriptions are for the main part of the system, other parts or functions that are not illustrated or explained may be present in the system.

### First Embodiment

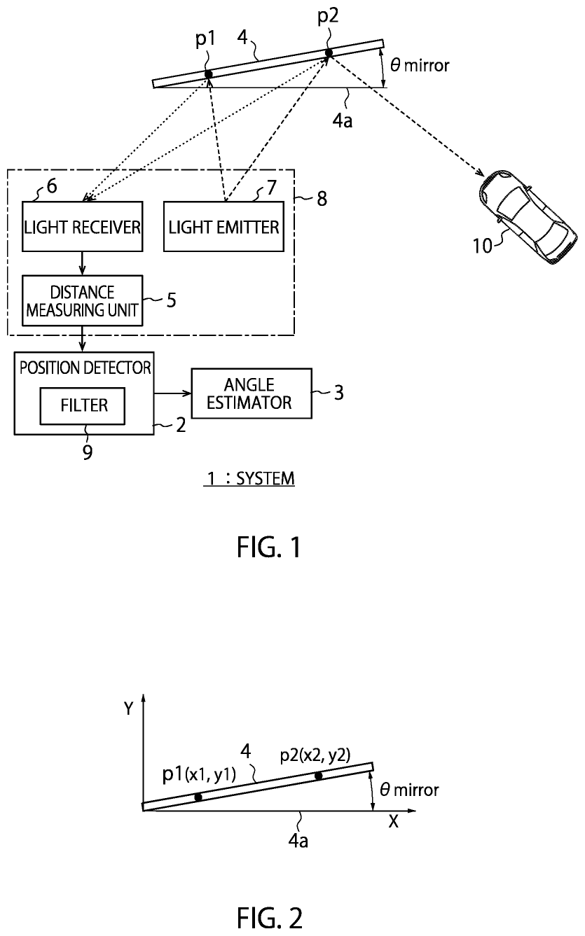

FIG. 1 is a block diagram illustrating a schematic configuration of a system 1 according to a first embodiment. The system 1 accurately estimates an angle of inclination of a reflective member 4 such as a mirror. The reflective member 4 such as a mirror may be anything that may reflect electromagnetic waves, like a traffic mirror set for drivers to see places that cannot be viewed from a driving road, a mirror set for crime prevention in a store for selling and buying articles, or a mirror set to expand the measurable range of a sensor such as a distance measuring unit 5 to reduce blind spot. Although the reflective member 4 is illustrated to have a plane structure, it may have a curved structure. In such a case, the angle of inclination may be estimated for each of narrower regions, for example each of regions obtained by dividing the reflective member 4. In the following descriptions, an example is described in which a distance between a vehicle running on a road and an object that is not viewed from the road but is present around the vehicle is measured using a plane traffic mirror during an automatic driving operation. However, occasions for measuring a distance are not limited to this case.

The system 1 shown in FIG. 1 includes a position detector (detector) 2 and an angle estimator (estimator) 3. The position detector 2 and the angle estimator 3 may be either disposed within one device or in separate devices. At least one of the position detector 2 and the angle estimator 3 may be disposed within a server connected to a cloud network, for example.

The position detector 2 detects position information on a first point p1 and a second point p2 of the reflective member 4 based on a first primary reflected electromagnetic wave and a second primary reflected electromagnetic wave included in received electromagnetic waves, the first primary reflected electromagnetic wave being an emitted electromagnetic wave reflected on the first point p1 and the second primary reflected electromagnetic wave being an emitted electromagnetic wave reflected on the second point p2. The reflective member 4 is, for example, a traffic mirror set within a range of the emitted electromagnetic waves. The reflective member 4 is capable of showing an object 10 present at a location that cannot be directly seen from the system 1.

The electromagnetic waves are typically laser lights or millimeter waves, but their frequency bands are not limited. The primary reflected electromagnetic waves are electromagnetic waves that are received by the system 1 after the reflection on the reflective member 4 without being re-reflected on the reflective member 4. The primary reflected electromagnetic waves therefore may be called “directly reflected electromagnetic waves,” which are electromagnetic waves reflected on the reflective member 4 and directly received by the system 1. The first primary reflected electromagnetic waves described above do not include electromagnetic waves reflected on the first point p1 of the reflective member 4, reflected one or more times on other objects, reflected again on the reflective member 4, and then received. Similarly, the second primary reflected electromagnetic waves do not include electromagnetic waves reflected on the second point p2 of the reflective member 4, reflected one or more times on other objects, reflected again on the reflective member 4, and then received.

The position information on the first point p1 and the second point p2 of the reflective member 4 detected by the position detector 2 indicates positions of the reflective member 4 on which the first primary reflected electromagnetic wave and the second primary reflected electromagnetic wave are reflected. Thus, if the electromagnetic waves are reflected on two or more different pints on the reflective member 4, the position detector 2 detects the position information on the two or more points. The angle of inclination of the reflective member 4 relative to a reference surface 4a may be calculated based on coordinates of at least two points on the reflective member 4. The position detector 2 therefore detects position information on at least two points (first point p1 and second point p2) that are needed to calculate the angle of inclination of the reflective member 4. How to determine whether the electromagnetic waves received by the system 1 are the first primary reflected electromagnetic wave and the second primary reflected electromagnetic wave reflected on the reflective member 4 will be described later.

The angle estimator 3 estimates the angle of inclination of the reflective member 4 relative to the reference surface 4a based on the position information on the at least two detected positions including the first point p1 and the second point p2. The reference surface 4a is, for example, a surface of the system 1 from which the electromagnetic waves are emitted, and may be arbitrarily set. The angle estimator 3 estimates the angle of inclination of the reflective member 4 to use it in converting a virtual image of the object 10 included in a distance image to a real image, as will be described later.

The system 1 shown in FIG. 1 may further include a distance measuring unit (measuring circuitry) 5. The distance measuring unit 5 detects position information on a first point and a second point of a reflective member based on a first primary reflected electromagnetic wave generated by a reflection of a first emitted pulse on the first point and a second primary reflected electromagnetic wave generated by a reflection of a second emitted pulse on the second point. More specifically, the distance measuring unit 5 measures a distance to a point where a received electromagnetic wave is reflected based on a time difference between the emission timing and the reception timing of the electromagnetic wave. If the electromagnetic wave is a laser light, the distance measuring unit 5 measures the distance based on the following expression (1).

Distance=Light Speed×(reception timing of reflected light−emission timing)/2 (1)

If the electromagnetic wave is a laser light, the system 1 shown in FIG. 1 may include a light receiver (receiver circuitry) 6, which includes such elements as a photodetector, an amplifier, a light receiving sensor, and an A/D converter, which are not shown. The light receiver 6 receives the first primary reflected electromagnetic wave and the second primary reflected electromagnetic wave. The reception timing of the first primary reflected electromagnetic wave is determined in accordance with when the light receiver 6 receives the first primary reflected electromagnetic wave, and the reception timing of the second primary reflected electromagnetic wave is determined in accordance with when the light receiver 6 receives the second primary reflected electromagnetic wave.

The photodetector receives part of the emitted laser light and converts it to an electrical signal. The amplifier amplifies the electrical signal outputted from the photodetector. The light receiving sensor converts the received laser light to an electrical signal. The A/D converter converts the electrical signal outputted from the light receiving sensor to a digital signal.

If the electromagnetic wave is a laser light, the system 1 shown in FIG. 1 may include a light emitter 7, which emits laser lights in a predetermined frequency band, for example. Laser light is coherent light with uniform phase and frequency. The light emitter 7 intermittently emits pulsed laser light at predetermined intervals. The cycle in which the light emitter 7 emits the laser light is longer than a period of time required for a distance measurement device to measure a distance indicated by each pulse of the laser light.

A light detection and ranging (LiDAR) device 8, which is a module including the light emitter 7, the light receiver 6, and the distance measuring unit 5 shown in FIG. 1, may be included as a component of the system 1 shown in FIG. 1. In the example described below, the electromagnetic waves are laser lights, and the light emitter 7 and the light receiver 6 are included in the system 1 shown in FIG. 1. The primary reflected electromagnetic waves described above will also be called “primary reflected laser light” below.

The primary reflected laser lights reflected on the reflective member 4 and received by the system 1 are mainly laser lights that are subjected to diffused reflection on the reflective member 4. A laser light incident on the reflective member 4 such as a traffic mirror is normally subjected to a regular reflection (also called as “forward reflection” or “specular reflection”). However, if there is a scratch or stain on the mirror surface of the reflective member 4, the laser light is not only subjected to the regular reflection but also subjected to diffused reflection (also called as “irregular reflection”). The laser light subjected to the diffused reflection on the reflective member 4 moves to various directions, may be received as a primary reflected laser light by the light receiver 6. The degree of stain on the surface of the reflective member 4 is dependent on the environment in which the reflective member 4 is set. The surface of the reflective member 4 may be made irregular due to the production error, which may cause the irregular reflection. Furthermore, as the time passes, scratches and dusts on the reflective member 4 increase, which may increase diffused reflection. Since the edge portion of the reflective member 4 is often formed of a resin or metal material having a low reflection ratio, the diffused reflection may sometimes be caused at the edge portion.

How the angle estimator 3 estimates the angle of inclination of the reflective member 4 relative to the reference surface 4a will then be described. FIG. 2 is a plan view of a plane reflective member 4 viewed from above. In FIG. 2, the emitting surface of the LiDAR device 8 is a horizontal surface, which is defined as the reference surface 4a, and the angle of inclination of the reflective member 4 relative to the reference surface 4a is defined as θmirror. In FIG. 2, the X axis represents the direction of the reference surface 4a, and the Y axis represents the normal to the horizontal surface.

In FIG. 2, the coordinates of the first point p1 and the second point p2 of the reflective member 4 defined by the position detector 2 are defined as (x1, y1) and (x2, y2). The angle of inclination θmirror of the reflective member 4 can be expressed as the following expression (2).

θmirror=arctan[(y2−y1)/(x2−x1))] (2)

Thus, if the coordinates of at least two points on the reflective member 4 are known, the angle of inclination θmirror of the reflective member 4 can be calculated easily. If the reflective member 4 is not only inclined relative to the reference surface 4a but also another reference surface that is perpendicular to the reference surface 4a, the angle of inclination of the reflective member 4 relative to the other reference surface may be calculated by using the above expression (2) if the coordinates of two points on the reflective member 4 relative to the other reference surface are detected. In this manner, the angle of inclination of the reflective member 4 inclined in an arbitrary direction within a three-dimensional space may be calculated.

As described above, the position detector 2 detects the position information on two or more points including the first point p1 and the second point p2 of the reflective member 4. The detection by the position detector 2 may be performed by using a filter 9, for example. The filter 9 eliminates signals corresponding to secondary and following reflected electromagnetic waves that are reflected on the reflective member 4, and extracts only signals corresponding to the first primary reflected electromagnetic wave and the second primary reflected electromagnetic wave. The filter 9 may extract signals using a neural network generated by learning the position and the shape of the reflective member 4 in advance. Alternatively, the filter 9 may extract signals through pattern matching with an image of the external appearance of the reflective member 4 taken in advance. Thus, the filter 9 may extract signals through arbitrarily selected signal processing.

The position detector 2 detects the position information on the first point p1 and the second point p2 based on the signals corresponding to the first primary reflected electromagnetic wave and the second primary reflected electromagnetic wave extracted by the filter 9. The filter 9 may be disposed within the position detector 2, or independently of the position detector 2.

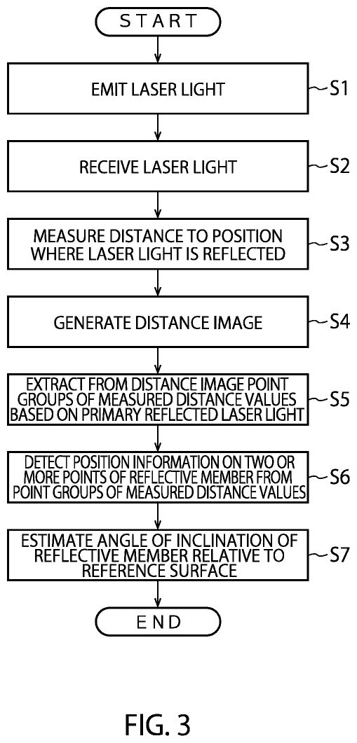

FIG. 3 is a flowchart of an operation of the system 1 according to the first embodiment. The process of the flowchart is performed when the light emitter 7 emits the laser light. The light emitter 7 emits the laser light (step S1), and the light receiver 6 receives the laser light (step S2). Since the light emitter 7 repeatedly emits the laser light at predetermined intervals, the light receiver 6 repeatedly receives the laser light. The distance measuring unit 5 measures a distance to a location at which the laser light received by the light receiver 6 is reflected based on emission timing at which the light emitter 7 emits the laser light and reception timing at which the light receiver 6 receives the laser light (step S3). The process in step S3 is performed every time the light receiver 6 receives the laser light. The light emitter 7 changing the direction in which the laser light is emitted while repeatedly emitting the laser light at the predetermined intervals. As a result, the distance measuring unit 5 may measure distances to a plurality of objects 10 located in various directions.

The distance measuring unit 5 then generates a distance image based on the result of the distance measurement performed in step S3 (step S4). In the distance image generated by the distance measuring unit 5, each of the objects 10 is expressed with a different color that is selected depending on its distance. In the distance image, respective distance values measured by the distance measuring unit 5 are expressed as point groups.

The filter 9 within the position detector 2 then extracts from the distance image point groups of the measured distance values generated based on the primary reflected laser lights reflected on two or more points of the reflective member 4, including the first primary reflected laser light and the second primary reflected laser light reflected on the first point p1 and the second point p2 of the reflective member 4, and eliminates the other point groups (step S5). The process of step S5 may be performed by a method of extracting point groups using a result of leaning an outer appearance of the reflective member 4 performed in advance, or a pattern matching method.

The position detector 2 then detects position information on two or more points including the first point p1 and the second point p2 of the reflective member 4 from the measured distance values obtained based on the primary reflected laser lights extracted by the filter 9 (step S6). More specifically, the position detector 2 detects coordinates of the two or more points including the first point p1 and the second point p2 on a predetermined two-dimensional coordinate axes.

The angle estimator 3 then estimates the angle of inclination of the reflective member 4 relative to the reference surface 4a based on the position information on the two or more points including the first point p1 and the second point p2. The angle of inclination may be calculated here based on the above-described expression (2), for example (step S7).

Thus, in the first embodiment, the system receives the primary reflected laser lights reflected on the reflective member 4, and detects the position information on the two or more points including the first point p1 and the second point p2 of the reflective member 4 on which the received primary reflected laser lights are reflected. The angle of inclination of the reflective member 4 relative to the reference surface 4a may be estimated from the position information on the two or more points.

### Second Embodiment

In a second embodiment, the primary reflected laser light is extracted based on the intensity of the laser light received by the light receiver 6.

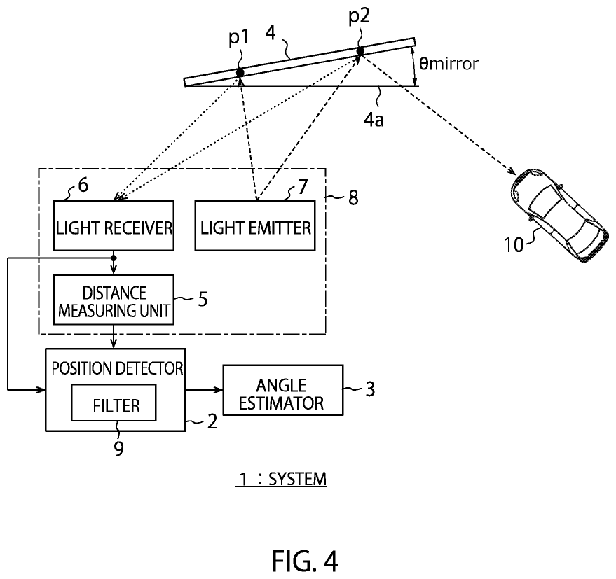

FIG. 4 is a block diagram illustrating a schematic configuration of a system 1 according to the second embodiment. The filter 9 of the system 1 shown in FIG. 4 receives information on the laser light received by the light receiver 6 instead of the distance image. The filter 9 according to the second embodiment extracts primary reflected laser lights reflected on two or more points including the first point p1 and the second point p2 of the reflective member 4 based on the amplitude (intensity) of the laser light received by the light receiver 6.

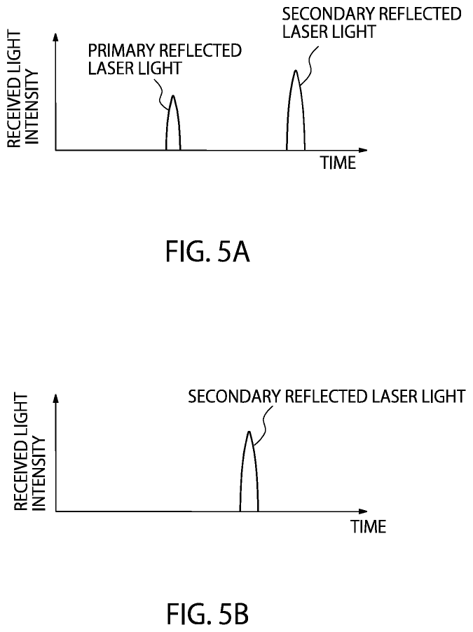

FIG. 5A is a diagram schematically showing the waveform of the laser lights received by the light receiver 6. As shown in FIG. 5A, after the primary reflected laser light from the reflective member 4 is received by the light receiver 6, the laser light (secondary reflected laser light) that is reflected on the object 10 and then reflected again on the reflective member 4 is received. The intensity of the secondary reflected laser light that is reflected on the object 10 is greater than the primary reflected laser light. The filter 9 therefore extracts the laser light that is received earlier and has a lower intensity than the laser light received later. If there is no reflective member 4 in the range of the laser light emitted by the light emitter 7, the light receiver 6 only receives the secondary reflected laser light reflected on the object 10 as shown in FIG. 5B since no primary reflected laser light is received by the light receiver 6.

In FIGS. 5A and 5B, no noise light such as ambient light received by the light receiver 6 is taken into account. The reason for this is that the intensity of noise light is generally considerably lower than the intensity of the laser light reflected on the object 10 and the intensity of the primary reflected laser light, and can be ignored. Under an environment including a relatively large amount of noise light, the noise light and the primary reflected laser light need to be distinguished from each other based on such conditions as the light intensity, the waveform of the received light, and the amplitude of the received light.

The position detector 2 detects the position information on the two or more points including the first point p1 and the second point p2 of the reflective member 4 based on the primary reflected laser light extracted by the filter 9.

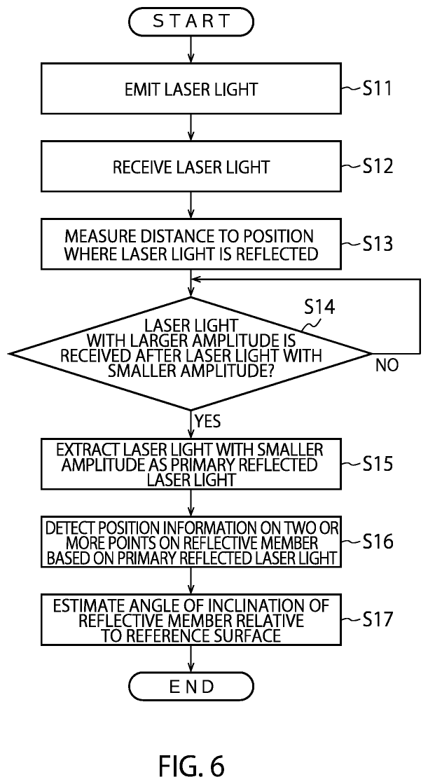

FIG. 6 is a flowchart of an operation of the system 1 according to the second embodiment. The processes of steps S11 to S13 are the same as those of step S1 to S3 shown in FIG. 3. Before or after step S13, The filter 9 determines whether a laser light having a larger amplitude is received after a laser light having a smaller amplitude (step S14). If the answer is YES in step S14, the laser light having a smaller amplitude is determined to be the primary reflected laser light reflected on the reflective member 4, and extracted (step S15). In step S15, primary reflected laser lights may be extracted based on a result of the learning of the amplitude of the primary reflected laser light and the ratio between the amplitude of the primary reflected laser light and the amplitude of the secondary reflected laser light.

The position detector 2 detects the position information on the two or more points including the first point p1 and the second point p2 of the reflective member 4 based on the extracted primary reflected laser lights (step S16). The angle estimator 3 estimates the angle of inclination of the reflective member 4 relative to the reference surface 4a based on the position information on the two or more points including the first point p1 and the second point p2 (step S17).

Thus, in the second embodiment, the primary reflected laser light reflected on the reflective member 4 is extracted based on the intensity and the reception timing of the laser light received by the light receiver 6. Accordingly, the primary reflected laser light may be extracted faster and more easily than the first embodiment, and therefore the angle of inclination of the reflective member 4 may be estimated in a faster manner.

### Third Embodiment

In a third embodiment, an imaging unit recognizes the reflective member 4, and the laser light received by the light receiver 6 is filtered based on the recognition result.

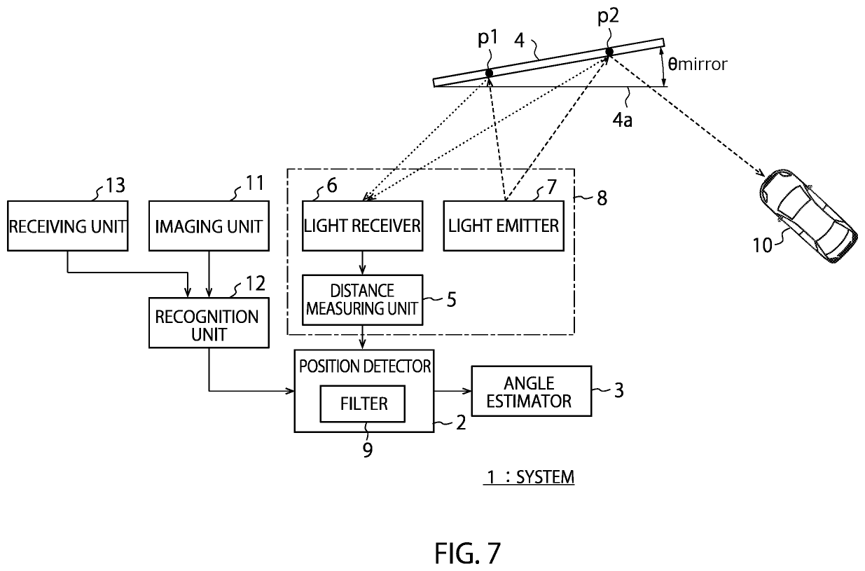

FIG. 7 is a block diagram illustrating a schematic configuration of a system 1 according to the third embodiment. The system 1 shown in FIG. 7 includes an imaging unit 11 and a recognition unit 12. The imaging unit 11 produces an image of an area around the system 1. The imaging unit 11 may be a still camera, or an image sensor such as a complementary metal oxide semiconductor (CMOS) sensor or a charge coupled device (CCD). Instead of or in addition to the imaging unit 11, a receiving unit 13 for receiving millimeter waves may be provided.

The recognition unit 12 recognizes the position of the reflective member 4 from the image produced by the imaging unit 11. The recognition unit 12 specifies the position and the shape of the reflective member 4 included in the image, using such a method as pattern matching. The recognition unit 12 may recognizes the reflective member 4 based on the millimeter waves received by the receiving unit 13. The recognition unit 12 may also recognize the reflective member 4 based on both the image produced by the imaging unit 11 and the millimeter waves received by the receiving unit 13.

The filter 9 included in the position detector 2 extracts measured distance values relating to the direction of the reflective member 4, which are recognized by the recognition unit 12. The measured distance values extracted by the filter 9 are based on the primary reflected laser lights reflected on the reflective member 4, and the position information on the two or more points including the first point p1 and the second point p2 of the reflective member 4 may be detected from the measured distance values.

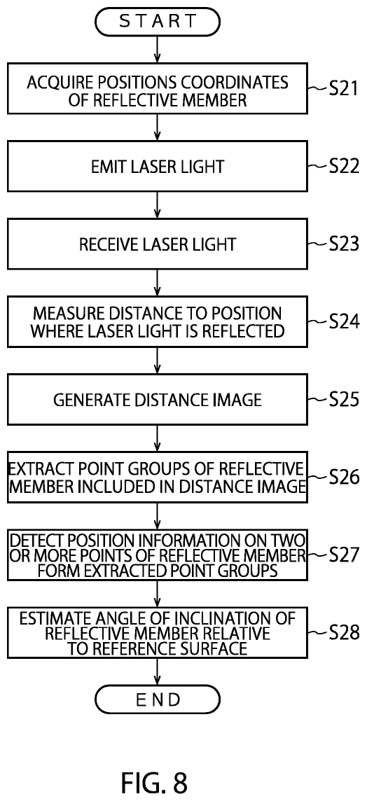

FIG. 8 is a flowchart of an operation of the system 1 according to the third embodiment. Before starting the distance measurement, the imaging unit 11 produces an image of an area surrounding the reflective member 4, and acquires position coordinates of the reflective member 4 included in the image (step S21). If the image is a camera image, the outer shape of the reflective member 4 may be recognized by such a method as pattern matching. The obtained position information on the reflective member 4 is used as supplemental information for determining approximately where the reflective member 4 is present in the distance image generated in step S25 that will be described later.

Then, the processes of steps S1 to S4 shown in FIG. 3 are performed to generate a distance image (steps S22 to S25). In step S25, only the position coordinates relating to the reflective member 4 are obtained by using the recognition result of the camera, for example, and point groups of the reflective member 4 are extracted based on the obtained position coordinates (step S26). The extraction accuracy of step S26 may be improved by obtaining only the portion of the distance image relating to the reflective member 4 in step S25, for example, and then step S26 is performed since the other portions of the distance image are not needed.

The position detector 2 then detects, from the point groups extracted in step S26, the position information on the two or more points including the first point p1 and the second point p2 based on the primary reflected laser lights reflected on the reflective member 4 (step S27). The angle estimator 3 estimates the angle of inclination of the reflective member 4 relative to the reference surface 4a based on the detected position information on the two or more points (step S28).

Thus, in the third embodiment, the reflective member 4 is recognized from the image produced by the imaging unit 11, the measured distance values are obtained from the direction of the recognized reflective member 4, and the position information on the two or more points including the first point p1 and the second point p2 of the reflective member 4 are detected. The position information of the reflective member 4 may be detected easily and accurately in this manner.

### Fourth Embodiment

In the first to third embodiments, the primary reflected laser lights from the reflective member 4 such as a traffic mirror are received by the light receiver 6 to detect the position information on the two or more points such as the first point p1 and the second point p2 of the reflective member 4. Therefore, in the first to third embodiments, it is a precondition that the primary reflected laser lights from the reflective member 4 are received by the light receiver 6. The primary reflected laser lights received by the light receiver 6 are part of laser lights emitted from the system 1 and subjected to the diffused reflection on the reflective member 4. It is therefore needed to have as large amount of laser light as possible that is subjected to the diffused reflection on the reflective member 4 so that the primary reflected laser light is reliably received by the light receiver 6.

The reflective member 4 such as a traffic mirror is placed on a road etc., and often has a mirror surface for the regular reflection (forward reflection). An ideal mirror surface reflects laser light to a direction that is determined by the incident direction of the laser light, and therefore the primary reflected laser light is received by the light receiver 6 only when the emitted laser light moves in the normal line direction of the mirror surface. Since the light receiver 6 scans the direction of the emitted laser light in a predetermined range, the amount of primary reflected laser lights received by the light receiver 6 cannot be increased.

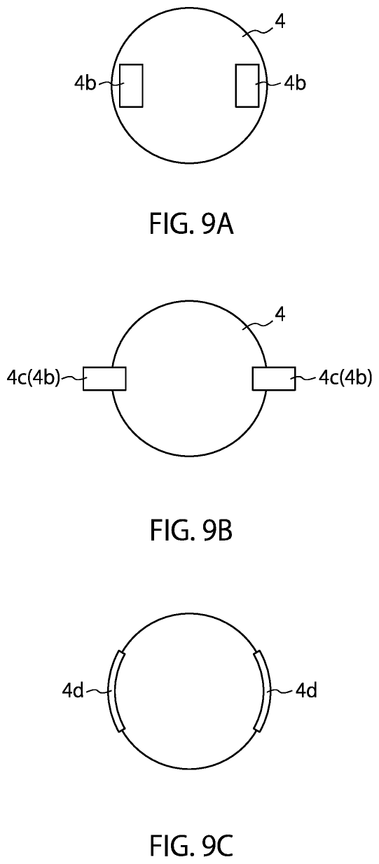

FIG. 9A is a diagram showing a first example of the reflective member 4 capable of increasing the ratio of diffused reflection. In the reflective member 4 shown in FIG. 9A, a diffusion member 4b is disposed on at least a part of a reflective surface to increase the amount of laser lights subjected to diffused reflection. Laser lights subjected to the diffused reflection on the diffusion member 4b move in various directions, and a portion of the laser lights is received by the light receiver 6 as the primary reflected laser lights. As the area of the diffusion member 4b on the reflective surface of the reflective member 4 increases, the amount of the primary reflected laser lights received by the light receiver 6 increases, but the amount of the laser lights subjected to the regular reflection on the reflective member 4 decreases. It is therefore preferable that the position, the shape, and the area of the diffusion member 4b on the reflective member 4 be decided in consideration of the trade-off between the amount of lights subjected to the diffused reflection and the amount of lights subjected to the regular reflection on the reflective member 4.

FIG. 9B is a diagram showing a second example of the reflective member 4 capable of increasing the ratio of diffused reflection. In the reflective member 4 shown in FIG. 9B, a partial protrusion 4c is disposed on an edge portion of the reflective member 4, and a diffusion member 4b is disposed on at least a part of the protrusion 4c. The second example shown in FIG. 9B is capable of increasing the amount of diffused reflection without decreasing the area for the regular reflection in the reflective member 4, and therefore the defect of the first example shown in FIG. 9A may be compensated.

FIG. 9C is a diagram showing an example of the reflective member 4 capable of improving the recognition rate of the recognition unit 12. In the reflective member 4 shown in FIG. 9C, special processing is performed on at least a part 4d of the reflective member 4 to help the recognition of the reflective member 4. As example of the special processing is a coating of a fluorescent paint, which glows at night, to help the imaging unit 11 produce an image, in which the position of the reflective member 4 may be easily recognized. In the example of FIG. 9C, the special processing is performed on two portions of the reflective member 4, but the fluorescent material may be painted on the entire edge portion of the reflective member 4 so that the outer shape of the reflective member 4 may be recognized at night.

Thus, in the fourth embodiment, the reflective member 4 is processed so as to increase the diffused reflection, or to be recognized easily. As a result, whether the laser light received by the light receiver 6 is the primary reflected laser light reflected on the reflective member 4 or not may be recognized more easily. Therefore, the position information on the two or more points including the first point p1 and the second point p2 of the reflective member 4 may be detected more easily and accurately.

### Fifth Embodiment

In a fifth embodiment, after the angle of inclination of the reflective member 4 relative to the reference surface 4a is estimated by using the system 1 according to any of the first to fourth embodiments, a virtual image included in the distance image is converted to a real image.

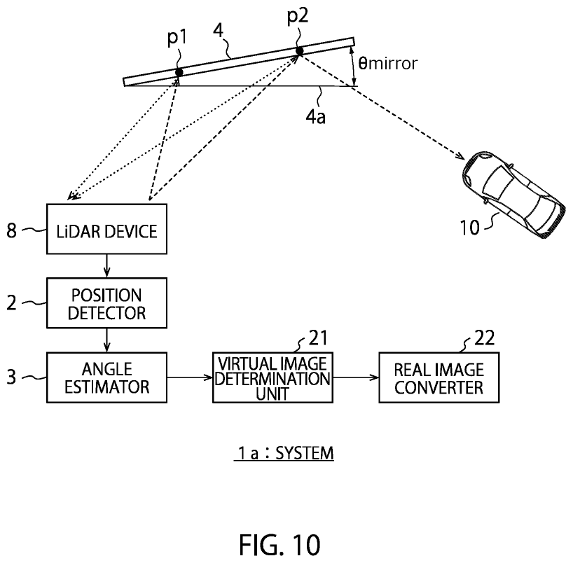

FIG. 10 is a block diagram showing a schematic configuration of a system 1a obtained by adding a virtual image determination unit 21 and a real image converter 22 to the system 1 according to any of the first to fourth embodiments.

The virtual image determination unit 21 determines a virtual image included in the distance image. The virtual image determination unit 21 determines an image as a virtual image, which is in a range of the image of the reflective member 4 included in the distance image and has larger measured distance values than the measured distance values obtained for the path to the reflective member 4.

The real image converter 22 converts the position of the virtual image to the position of a real image based on the virtual image determined by the virtual image determination unit 21 and the angle of inclination of the reflective member 4 relative to the reference surface 4a estimated by the angle estimator 3, and generates a new distance image.

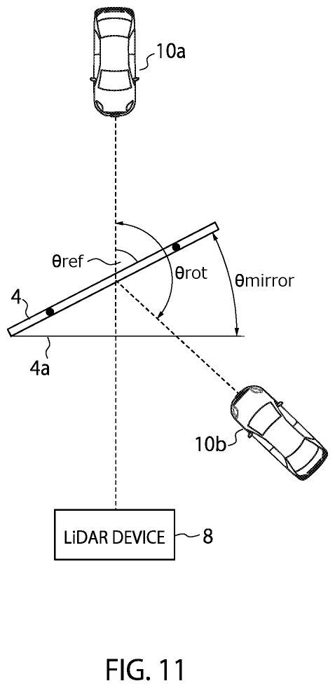

FIG. 11 is a diagram for explaining the operation of the real image converter 22. In the reflective member 4 shown in FIG. 11, the reference surface 4a is parallel to the emission surface for emitting the laser lights of the light emitter 7, and the reflection surface is inclined by @mirror relative to the reference surface 4a. In the example of FIG. 11, the angle θref made by the reflection surface and a line connecting the light receiver 6 and the virtual image 10a may be calculated by the following expression (3):

θref=180°−θmirror (3)

The real image 10b is located opposite to the virtual image 10a relative to a plane of symmetry, the reflection surface. Therefore, the angle θrot made by the line connecting the light receiver 6 and the virtual image 10a and a line connecting the real image 10b and the intersection of the reflection surface and the line connecting the light receiver 6 and the virtual image 10a may be calculated by the following expression (4).

θrot=(180−2×θmirror) (4)

Thus, when the reflection angle θmirror of the reflective member 4 is acquired at the angle estimator 3, the position of the virtual image may be converted to the position of the real image based on the expression (4).

In actual cases, it is necessary to adjust the reference point on the reflection surface for converting a virtual image to a real image in accordance with the position of the virtual image in the distance image. A specific position on the reflection surface, for example an average position of two or more points including the first point p1 and the second point p2 detected by the position detector 2, may be used as the reference point in converting a virtual image to a real image in order to easily conduct the position conversion.

It may be possible that the distance image obtained by converting the virtual image to the real image at the real image converter 22 becomes greater in size than the distance image before the conversion, because, depending on the angle of inclination of the reflective member 4, the position of the real image obtained by converting the virtual image using the refection surface as the plane of symmetry may sometimes be present far outside the range of the light receiver 6 to receive lights. Therefore, when the distance image obtained by converting the virtual image to the real image is displayed on a display device, it may be needed to prepare a display device with a larger screen than a display device having a screen suitable in size for displaying the virtual image.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A system comprising:
detection circuitry configured to detect position information on a first point and a second point of a reflective member based on a first primary reflected electromagnetic wave generated by a reflection of a first emitted pulse on the first point and a second primary reflected electromagnetic wave generated by a reflection of a second emitted pulse on the second point; and
processing circuitry configured to estimate an angle of inclination of the reflective member relative to a reference surface of the detection circuitry based on the position information on the first point and the second point.

2. The system according to claim 1, further comprising measurement circuitry configured to measure a first distance to the first point based on a difference in time between emission timing of the first emitted pulse and reception timing of the first primary reflected electromagnetic wave, and measure a second distance to the second point based on a difference in time between emission timing of the second emitted pulse and reception timing of the second primary reflected electromagnetic wave,
wherein the detection circuitry is further configured to detect the position information on the first point and the second point based on the first distance and the second distance.

3. The system according to claim 2, further comprising receiver circuitry configured to receive the first primary reflected electromagnetic wave and the second primary reflected electromagnetic wave,
wherein the reception timing of the first primary reflected electromagnetic wave is determined in accordance with when the receiver circuitry receives the first primary reflected electromagnetic wave, and the reception timing of the second primary reflected electromagnetic wave is determined in accordance with when the receiver circuitry receives the second primary reflected electromagnetic wave.

4. The system according to claim 3, further comprising an emitter configured to emit the electromagnetic waves,
wherein the receiver circuitry receives the electromagnetic waves after the emitter emits the electromagnetic waves.

5. The system according to claim 1,
wherein the first primary reflected electromagnetic wave is not a reflected electromagnetic wave emitted, reflected on the first point of the reflective member, reflected on one or more objects, reflected again on the reflective member and received by the detection circuitry, and
wherein the second primary reflected electromagnetic wave is not a reflected electromagnetic wave emitted, reflected on the second point of the reflective member, reflected on one or more objects, reflected again on the reflective member and received by the detection circuitry.

6. The system according to claim 1, further comprising a filter configured to extract signals corresponding to the first primary reflected electromagnetic wave and the second primary reflected electromagnetic wave by eliminating signals corresponding to secondary and following reflected electromagnetic waves reflected on the reflective member and received,
wherein the detection circuitry detects the position information on the first point and the second point based on the signals corresponding to the first primary reflected electromagnetic wave and the second primary reflected electromagnetic wave extracted by the filter.

7. The system according to claim 6, further comprising a recognition circuitry configured to recognize a location of the reflective member,
wherein the filter eliminates signals corresponding to the secondary and following reflected electromagnetic waves reflected on the reflective member at the recognized location and received, and extracts the signals corresponding to the first primary reflected electromagnetic wave and the second primary reflected electromagnetic wave.

8. The system according to claim 7, further comprising at least one of an imaging circuitry configured to produce an image of an area including the reflective member and a receiver circuitry configured to receive electronic waves reflected on the reflective member,
wherein the recognition circuitry recognizes the location of the reflective member based on at least one of the image produced by the imaging circuitry and an intensity of an electronic wave received by the receiver circuitry.

9. The system according to claim 8, further comprising a leaning circuitry configured to learn an outer shape of the reflective member,
wherein the recognition circuitry recognizes the location of the reflective member based on a result of leaning by the learning circuitry and at least one of the image produced by the imaging circuitry and the intensity of the electronic wave received by the receiver circuitry.

10. The system according to claim 1, further comprising a filter configured to extract the first primary reflected electromagnetic wave reflected on the first point of the reflective member and received, and the second primary reflected electromagnetic wave reflected on the second point and received based on amplitudes of the electromagnetic waves received,
wherein the detection circuitry detects the position information on the first point and the second point based on the first primary reflected electromagnetic wave and the second primary reflected electromagnetic wave extracted by the filter.

11. The system according to claim 10, wherein the filter extract, as the first primary reflected electromagnetic wave and the second primary reflected electromagnetic wave, electromagnetic waves having a smaller amplitude than secondary reflected electromagnetic waves that are received after being reflected on an object and received earlier than the secondary reflected electromagnetic waves.

12. The system according to claim 1, wherein the reference surface is an emission surface from which the electromagnetic waves are emitted.

13. A system comprising:
a measurement circuitry configured to measure a distance to a point on which electromagnetic waves that is received is reflected based on a difference in time between emission timing at which the electromagnetic wave is emitted and reception timing at which the electromagnetic wave is received, and to produce a distance image based on the distance measured;
a detection circuitry configured to detect position information on a first point and a second point of a reflective member based on a first primary reflected electromagnetic wave generated by a reflection of a first emitted pulse on the first point and a second primary reflected electromagnetic wave generated by a reflection of a second emitted pulse on the second point;
processing circuitry that estimates an angle of inclination of the reflective member relative to a reference surface based on the position information on the first point and the second point, determines a virtual image included in the distance image, and produces a new distance image by converting a position of the virtual image to a position of a real image based on the virtual image that is determined and the angle of inclination of the reflective member relative to the reference surface estimated by the angle estimator.

14. The system according to claim 13, further comprising a measurement circuitry configured to measure a first distance to the first point based on a difference in time between emission timing of the first emitted pulse and reception timing of the first primary reflected electromagnetic wave, and measure a second distance to the second point based on a difference in time between emission timing of the second emitted pulse and reception timing of the second primary reflected electromagnetic wave,
wherein the detection circuitry is further configured to detect the position information on the first point and the second point based on the first distance and the second distance.

15. The system according to claim 14, further comprising a receiver circuitry configured to receive the first primary reflected electromagnetic wave and the second primary reflected electromagnetic wave,
wherein the reception timing of the first primary reflected electromagnetic wave is determined in accordance with when the receiver circuitry receives the first primary reflected electromagnetic wave, and the reception timing of the second primary reflected electromagnetic wave is determined in accordance with when the receiver circuitry receives the second primary reflected electromagnetic wave.

16. The system according to claim 15, further comprising an emitter configured to emit the electromagnetic waves,
wherein the receiver circuitry receives the electromagnetic waves after the emitter emits the electromagnetic waves.

17. The system according to claim 13,
wherein the first primary reflected electromagnetic wave is not a reflected electromagnetic wave emitted, reflected on the first point of the reflective member, reflected on one or more objects, reflected again on the reflective member and received by the system, and
wherein the second primary reflected electromagnetic wave is not a reflected electromagnetic wave emitted, reflected on the second point of the reflective member, reflected on one or more objects, reflected again on the reflective member and received by the system.

18. A method comprising:
detecting position information on a first point and a second point of a reflective member based on a first primary reflected electromagnetic wave generated by a reflection of a first emitted pulse on the first point and a second primary reflected electromagnetic wave generated by a reflection of a second emitted pulse on the second point; and
estimating an angle of inclination of the reflective member relative to a reference surface of the reflective member based on the position information on the first point and the second point.

19. The method according to claim 18, wherein a diffusion member for diffusing the emitted electromagnetic waves is disposed on at least a part of the reflective member.

20. The method according to claim 18,
wherein at least a part of the reflective member is subjected to special processing for recognition of the reflective member.
